(19) United States
(12) Patent Application Publication
(10) Pub. No.: US 2015/0285376 A1
(43) Pub. Date: Oct. 8, 2015

(54) BICYCLE GEAR SHIFT INDICATOR AND DISPLAY

(71) Applicant: Colleen M. Hageman, Portland, OR (US)

(72) Inventor: Colleen M. Hageman, Portland, OR (US)

(21) Appl. No.: 14/244,756

(22) Filed: Apr. 3, 2014

(51) Int. Cl. F16H 63/42; B62J 99/00

(52) U.S. Cl. CPC F16H 63/42; B62J 99/00; B62J 2099/0033; B62J 2099/008; B62J 2099/002

(57) ABSTRACT

Embodiments herein generally provide a rearward facing display for use with a bicycle. The display may show the current position of one or more derailleurs associated with the bicycle. As such, the display may indicate to a second rider following a first rider the current gears in use by the first rider as well as the shifting behavior of the first rider. In this manner, a novice rider may learn gear usage and shifting habits from a more experienced rider.

### TECHNICAL FIELD

Embodiments herein relate to the field of displays, and, more specifically, to a rearward facing display for indicating the current gear of a bicycle.

### BACKGROUND

Bicycles typically include front and/or rear derailleurs for shifting gears depending upon road conditions and desired speed. The derailleurs may be manipulated by the person riding the bike to change gears and increase or decrease the peddling resistance accordingly. Indicators are often included on the handlebars of the bike to display the current position of the derailleurs to the rider. This information may be useful in determining how to change gears.

When a novice rider is learning to change gears, they may find it challenging to select the preferred gear for a given situation. They may also experience difficulty in knowing when to shift gears in anticipation of upcoming events, such as hills, stops, starts, turns, and/or traffic. The novice rider may find it beneficial to know when a more experienced rider is shifting gears or what gear the more experience rider is using for a particular situation.

### BRIEF DESCRIPTION OF THE DRAWINGS

Embodiments will be readily understood by the following detailed description in conjunction with the accompanying drawings and the appended claims. Embodiments are illustrated by way of example and not by way of limitation in the figures of the accompanying drawings.

FIG. 1 illustrates a bicycle including a display according to various embodiments.

FIG. 2 illustrates the handlebars of a bicycle according to various embodiments.

FIG. 3 illustrates a portion of a bicycle seen from the rear including a display according to various embodiments.

### DETAILED DESCRIPTION OF DISCLOSED EMBODIMENTS

In the following detailed description, reference is made to the accompanying drawings which form a part hereof, and in which are shown by way of illustration embodiments that may be practiced. It is to be understood that other embodiments may be utilized and structural or logical changes may be made without departing from the scope. Therefore, the following detailed description is not to be taken in a limiting sense, and the scope of embodiments is defined by the appended claims and their equivalents.

Various operations may be described as multiple discrete operations in turn, in a manner that may be helpful in understanding embodiments; however, the order of description should not be construed to imply that these operations are order dependent.

The description may use perspective-based descriptions such as up/down, back/front, and top/bottom. Such descriptions are merely used to facilitate the discussion and are not intended to restrict the application of disclosed embodiments.

The terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still cooperate or interact with each other.

For the purposes of the description, a phrase in the form “A/B” or in the form “A and/or B” means (A), (B), or (A and B). For the purposes of the description, a phrase in the form “at least one of A, B, and C” means (A), (B), (C), (A and B), (A and C), (B and C), or (A, B and C). For the purposes of the description, a phrase in the form “(A)B” means (B) or (AB) that is, A is an optional element.

The description may use the terms “embodiment” or “embodiments,” which may each refer to one or more of the same or different embodiments. Furthermore, the terms “comprising,” “including,” “having,” and the like, as used with respect to embodiments, are synonymous, and are generally intended as “open” terms (e.g., the term “including” should be interpreted as “including but not limited to,” the term “having” should be interpreted as “having at least,” the term “includes” should be interpreted as “includes but is not limited to,” etc.).

With respect to the use of any plural and/or singular terms herein, those having skill in the art can translate from the plural to the singular and/or from the singular to the plural as is appropriate to the context and/or application. The various singular/plural permutations may be expressly set forth herein for sake of clarity.

In various embodiments, methods, apparatuses, and systems for displaying the current gear of a bicycle on a rearward facing display. In this manner a person, such as an individual riding another bike, may know the current gear of the person riding ahead of them. This may allow a novice rider to learn the appropriate gear for a given situation as well as the best time to change gears by mimicking the behavior of a more experience rider. By using a rearward facing display, this may be possible without verbal communication between the riders, which can be difficult in many riding situations. In addition to use as a training aid, the display device of the current application may also be used in a competitive manner. For instance, a rider may want to show another rider that they ride up a particular hill without downshifting into an easier gear. The display apparatus of the current application, may allow the rider to effectively communicate their current gear setting when passing another rider.

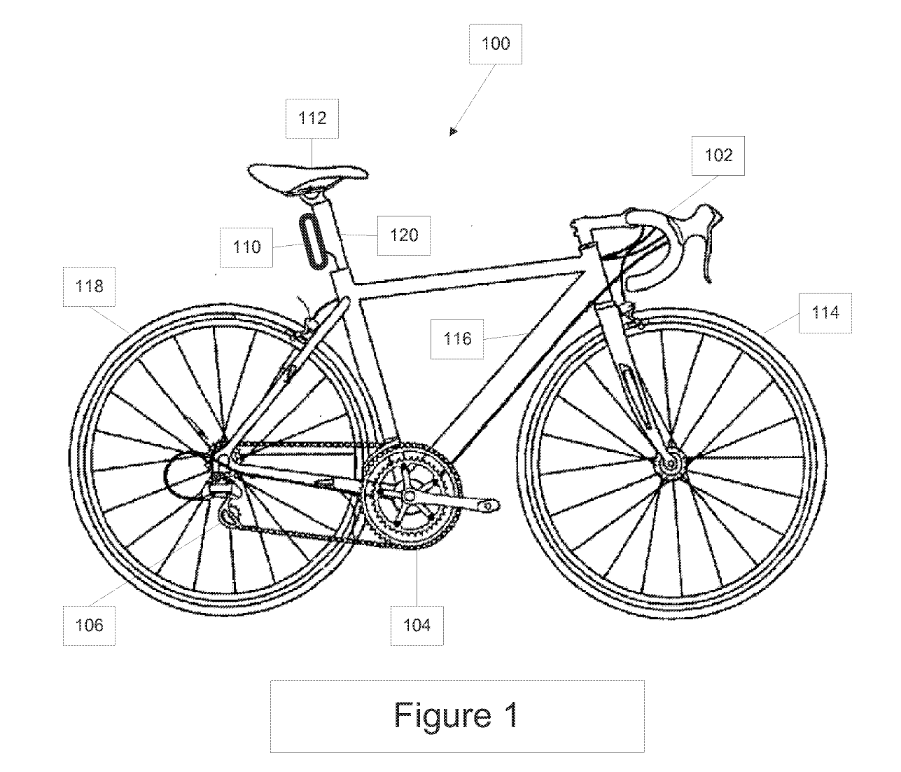

FIG. 1 shows a bicycle 100 including a display apparatus 110. The bike 100 includes a frame 116. Other components may be mounted to the frame 116. The bike 100 may include a front tire 114 and a rear tire 118 each mounted to the frame 116. The bike 100 may also include handlebars 102 for use in steering the bike 100. Brakes and shifters (not labeled in FIG. 1) may be attached to the handlebars 102 to assist a rider in controlling the bike 100. The bike 100 may also include a seat 112 coupled to the frame 116 by a slidable seat post 120. Seat post 120 may be slid into the frame 116 to vary the height of the seat 112.

The bike 100 may include a front derailleur 104. Pedals (not shown in FIG. 1) may be attached to the gears associated with the front derailleur 104 such that a rider may provide motive power to the gears. The gears associated with the front derailleur 104 may be coupled to gears associated with a rear derailleur 106 by a chain, belt or another means of transferring power from one gear to another gear. In this manner motive power input to the pedals may be transmitted to the gears associated with the rear derailleur 106 to rotate the rear tire 118 and move the bike forward. The number of teeth associated with the front and rear gear being used at a given time determines a gear ratio of the bike. Front and rear derailleurs 104, 106 allow the rider to change which gear is being used (which gear the chain or belt is coupled to) and thus set a gear ratio for a particular situation.

If the rider wishes to go faster, they can either move the chain or belt to a front gear having more teeth or move the chain or belt to rear gear having fewer teeth to increase the gear ratio. The rider may do the opposite to decrease the gear ratio making it easier to pedal, for instance when going up a hill, or starting from a stop. As a rider becomes more experienced, he or she tends to develop a feel for what gears are best suited to given riding situations. The experienced rider may also learn to preemptively shift gears when they know a change in riding conditions is coming. For instance, a more experienced rider may down shift when coming to a stop in order to make it easier to start. Selecting the appropriate gear and knowing when to change gears may be challenging for more novice riders, thus it may be beneficial for novice riders to be aware of the gear shifting behavior of more experienced riders.

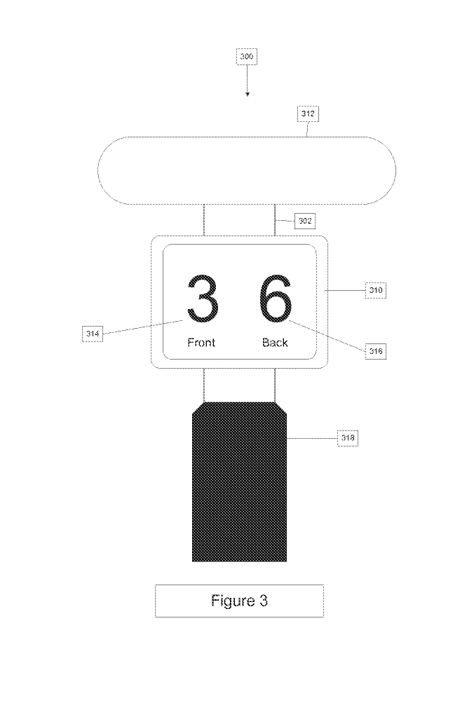

The bike 100 may include a display 110 (shown in detail in FIG. 3) mounted to the seat post 120. The display 110 may face rearward and be generally perpendicular to the frame 116 and rear tire 118. The display 110 may be configured to indicate the current position of both the front and rear derailleurs 104, 106. In this manner, a person, such as another rider, located behind the bike 100 may read the display and know the gears being used by the rider of the bike 100. Thus, a novice rider may ride behind a more experienced rider using a bike 100 with a display 110 and be aware of the gears in use and the shifting behavior of the more experienced rider without having to communicate verbally or through hand gestures, both of which may be difficult and/or dangerous in certain riding situations.

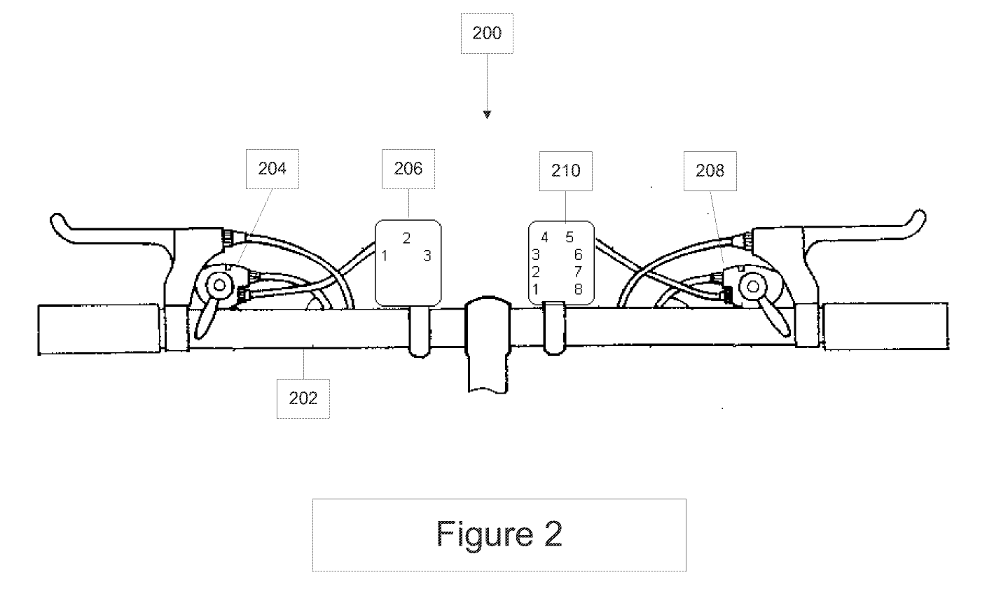

FIG. 2 shows handlebars 200 which may include a cross member 202. Front shift mechanism 204 and rear shift mechanism 208 may be mounted to the cross member 202. Front and rear shift mechanisms 204, 206 may include triggers, levers, or other actuating mechanisms by which a rider may change gears (move the chain of belt from one gear to another). In some instances the front and rear shift mechanisms 204, 206 may be mechanical such that movement of the trigger, lever, or other actuating mechanism is translated to the derailleur by a cable to move the chain or belt from one gear to another. In some embodiments, the derailleurs 104, 106 may be electronic such that a signal is sent from the shift mechanisms 204, 206 to an electronic device such as a solenoid or motor to move the chain or belt from one gear to another.

A front derailleur display 206 may be included as part of handlebars 200. For instances the front derailleur display 206 may be mounted to the cross member 202. The front derailleur display 206 may be connected to the front shift mechanism 204. The front derailleur display 206 may be configured to show the current position of the chain. In a mechanical system, the front derailleur display 206 may be connected to a cable that is operable to change the display when the chain or belt is moved from one gear to another. In an electronic system, front derailleur display 206, may include an electronic display using lights (such as light emitting diodes, LEDs) or screen (such as a liquid crystal display, LCD). Although shown as separate components, front derailleur display 206 and front shift mechanism 204 may be combined into a single component.

A rear derailleur display 210 may also be included as part of the handlebars. The rear derailleur display 210 may be attached and configured similar to the front derailleur display 206, discussed above, with the exception that the rear derailleur display 210 may be configured to show the position of the rear derailleur 106, as opposed to front derailleur 104.

The combination of the front derailleur display 206 and the rear derailleur display 210 allow the rider to quickly know which gears are in use. This information can be important when deciding when and how to shift gears. By including the front and rear derailleur displays 206, 210 on the handlebars 200, the gear information is readily available to the rider, but is not available to others, such as another rider following behind the first rider.

FIG. 3 shows a portion of a bicycle 300 as seen from the rear (such as by a rider following another rider). A seat 312 may be connected to a frame 318 by way of a seat post 302. The seat post 302 may be received in the frame 318 in a slideable manner such that the height of seat 312 may be adjusted.

A display 310 may be mounted to the seat post 302 such that the display faces rearward. The display 310 may be mounted such that it is generally vertical and perpendicular to the frame and/or rear tire of the bike. The display 310 may include a first display portion 314 and a second display portion 316.

The first display portion 314 may be configured to show the position of the front derailleur of the bicycle. In some embodiments the display 310 may be coupled to the shift mechanism or the derailleur displays (as discussed above with reference to FIG. 2) to receive information from the shift mechanism or the derailleur displays regarding the current gear in use. The display may be directly coupled, such as by a mechanical cable to the shift mechanism or the derailleur display. In some embodiments a mechanical or electronic sensor may be used to detect the position of the shift mechanism or the derailleur display. This information may then be sent to the display mechanically via a cable or electronically through a wired or wireless signal to be displayed on the display 310. In some embodiments mechanical or electronic sensors may directly detected the position of the front and rear derailleurs 104, 106 or the position of the chain or belt rather than monitoring the shift mechanism or the derailleur display.

The second display portion 316 may be configured to show the position of the rear derailleur. Any of the different sensing techniques discussed above with reference to the first display portion 314 may also be used to gather and communicate information regarding the position of the rear derailleur 106.

The display 310 may be of sufficient size to be read easily by a person following the bike. In this manner, the display 310 may communicate gear information to another rider to aid a more novice rider in learning appropriate gears and gear shifting behavior. In some embodiments the display may be at least approximately 1.5 inches tall and approximately 3 inches wide. In some embodiments, the display may be at least approximately 2 inches tall and approximately 4 inches wide.

The display 310 may be formed with significant contrast to aid in readability. In some embodiments the display 310 may utilize a white or yellow background with black numbers. In some embodiments the display 310, may use a dark (such as black) background with white or yellow numbers.

In some embodiments the display 310 may also incorporate one or more lights. For instance, in some embodiments the numbers or background may be configured to light up. As such the display 310 may be more readable and may also serve as a tail light for visibility when used in low light conditions. In some embodiments, portions of the display 310 may blink in a manner known with other bicycle tail lights to improve visibility. In some embodiments, the display may be configure to flash or blink a predetermined number of times when the value displayed in either the first display portion 314 or the second display portion 316 changes. In this manner, the display 310 may be configured to draw attention to a recent change in the position of one or both of the derailleurs.

A few non-limiting examples are included below.

Example 1 includes a display apparatus comprising: a display portion configured to display the current gear of a bicycle; and a mounting bracket configured to mount the display apparatus to a bicycle such that display portion faces rearward and is approximately perpendicular to the length of the bicycle.

Example 2 includes the display apparatus of example 1, wherein the display portion comprises a first display portion configured to display a position of a first derailleur; a second display portion configured to display a position of a second derailleur.

Example 3 includes the display apparatus of example 2, wherein the display apparatus is configured to receive the position of the first derailleur via a first cable and is further configured to receive the position of the second derailleur via a second cable.

Example 4 includes the display apparatus of example 2, wherein the display apparatus is configured to receive the position of the first derailleur from a first sensor and is further configured to receive the position of the second derailleur from a second sensor.

Example 5 includes the display apparatus of example 4, wherein the first sensor is configured to sense the position of a first display indicator and the second sensor is configured to sense the position of a second display indicator.

Example 6 includes the display apparatus of example 4, wherein the first sensor is configured to sense the position of the first derailleur and the second sensor is configured to sense the position of the second derailleur.

Example 7 includes the display apparatus of example 1, wherein the display portion is at least 1.5 inches tall and at least 3 inches wide.

Example 8 includes the display apparatus of example 1, wherein the mounting bracket is configured to mount the display apparatus to a seat post of a bicycle.

Example 9 includes a method of displaying a bicycle gear, the method comprising: receiving information regarding a position of a first derailleur; displaying the position of the first derailleur on a first portion of a rearward facing display apparatus; receiving information regarding a position of a second derailleur; and displaying the position of the second derailleur on a second portion of the rearward facing display apparatus.

Example 10 includes the method of example 9, wherein receiving information regarding a position of a first derailleur includes receiving tension associated with a first cable; and receiving information regarding a position of a second derailleur includes receiving tension associated with a second cable.

Example 11 includes the method of example 9, wherein receiving information regarding a position of a first derailleur includes receiving information from a first sensor; and receiving information regarding a position of a second derailleur includes receiving information from a second sensor.

Example 12 includes the method of example 11, wherein the first sensor is configured to sense the position of a first display indicator and the second sensor is configured to sense the position of a second display indicator.

Example 13 includes the method of example 11, wherein the first sensor is configured to sense the position of the first derailleur and the second sensor is configured to sense the position of the second derailleur.

Example 14 includes a system comprising: a frame having a front portion and a rear portion; at least one shiftable gearing mechanism coupled to the frame; a display apparatus coupled such that it approximately vertical and approximately perpendicular to the frame; wherein the display apparatus is configured to display a current position of the at least one shiftable gearing mechanism.

Example 15 includes the system of example 14 wherein the at least one shiftable gearing mechanism includes: a first derailleur; and a second derailleur configured to receive power from the first derailleur via a chain or belt and further configured to drive an axle.

Example 16 includes the system of example 15 wherein the display apparatus comprises: a first display portion configured to display the position of the first derailleur; a second display portion configured to display the position of the second derailleur.

Example 17 includes the system of example 14, further comprising a seat post coupled to the frame and configured to hold a seat wherein the display apparatus is mounted to the seat post in rearward facing position.

Although certain embodiments have been illustrated and described herein, it will be appreciated by those of ordinary skill in the art that a wide variety of alternate and/or equivalent embodiments or implementations calculated to achieve the same purposes may be substituted for the embodiments shown and described without departing from the scope. Those with skill in the art will readily appreciate that embodiments may be implemented in a very wide variety of ways. This application is intended to cover any adaptations or variations of the embodiments discussed herein. Therefore, it is manifestly intended that embodiments be limited only by the claims and the equivalents thereof.

What is claimed is:

1. A display apparatus comprising:
a display portion configured to display the current gear of a bicycle; and
a mounting bracket configured to mount the display apparatus to a bicycle such that display portion faces rearward and is approximately perpendicular to the length of the bicycle.

2. The display apparatus of claim 1, wherein the display portion comprises:
a first display portion configured to display a position of a first derailleur;
a second display portion configured to display a position of a second derailleur.

3. The display apparatus of claim 2, wherein the display apparatus is configured to receive the position of the first derailleur via a first cable and is further configured to receive the position of the second derailleur via a second cable.

4. The display apparatus of claim 2, wherein the display apparatus is configured to receive the position of the first derailleur from a first sensor and is further configured to receive the position of the second derailleur from a second sensor.

5. The display apparatus of claim 4, wherein the first sensor is configured to sense the position of a first display indicator and the second sensor is configured to sense the position of a second display indicator.

6. The display apparatus of claim 4, wherein the first sensor is configured to sense the position of the first derailleur and the second sensor is configured to sense the position of the second derailleur.

7. The display apparatus of claim 1, wherein the display portion is at least 1.5 inches tall and at least 3 inches wide.

8. The display apparatus of claim 1, wherein the mounting bracket is configured to mount the display apparatus to a seat post of a bicycle.

9. A method of displaying a bicycle gear, the method comprising:
receiving information regarding a position of a first derailleur;
displaying the position of the first derailleur on a first portion of a rearward facing display apparatus;
receiving information regarding a position of a second derailleur; and
displaying the position of the second derailleur on a second portion of the rearward facing display apparatus.

10. The method of claim 9, wherein receiving information regarding a position of a first derailleur includes receiving tension associated with a first cable; and receiving information regarding a position of a second derailleur includes receiving tension associated with a second cable.

11. The method of claim 9, wherein receiving information regarding a position of a first derailleur includes receiving information from a first sensor; and receiving information regarding a position of a second derailleur includes receiving information from a second sensor.

12. The method of claim 11, wherein the first sensor is configured to sense the position of a first display indicator and the second sensor is configured to sense the position of a second display indicator.

13. The method of claim 11, wherein the first sensor is configured to sense the position of the first derailleur and the second sensor is configured to sense the position of the second derailleur.

14. A system comprising:
a frame having a front portion and a rear portion;
at least one shiftable gearing mechanism coupled to the frame;
a display apparatus coupled such that it approximately vertical and approximately perpendicular to the frame;
wherein the display apparatus is configured to display a current position of the at least one shiftable gearing mechanism.

15. The system of claim 14 wherein the at least one shiftable gearing mechanism includes:
a first derailleur; and
a second derailleur configured to receive power from the first derailleur via a chain or belt and further configured to drive an axle.

16. The system of claim 15 wherein the display apparatus comprises:
a first display portion configured to display the position of the first derailleur;
a second display portion configured to display the position of the second derailleur.

17. The system of claim 14, further comprising a seat post coupled to the frame and configured to hold a seat wherein the display apparatus is mounted to the seat post in rearward facing position.
